(19) United States
(12) Patent Application Publication
(10) Pub. No.: US 2014/0070705 A1
(43) Pub. Date: Mar. 13, 2014

(54) LED DRIVING APPARATUS AND OPERATING METHOD THEREOF

(71) Applicant: Raydium Semiconductor Corporation, Hsinchu (TW)

(72) Inventors: Chung-Tai Cheng, Zhubei City (TW); Chia-Hsiu Lin, Hsinchu City (TW)

(73) Assignee: Raydium Semiconductor Corporation, Hsinchu (TW)

(21) Appl. No.: 14/025,492

(22) Filed: Sep. 12, 2013

(30) Foreign Application Priority Data
Sep. 13, 2012 (TW) 101133510

(51) Int. Cl. H05B 33/08

(52) U.S. Cl. CPC H05B 33/0815
USPC 315/121

(57) ABSTRACT

A LED driving apparatus and an operating method thereof are disclosed. The LED driving apparatus includes an output stage, a reference voltage regulator, a first input resistor, a second input resistor, and a controller. The output stage includes at least one LED. The reference voltage regulator is coupled to an input voltage and used to receive the input voltage and output a reference voltage signal. One end of the first input resistor is coupled to a node. One end of the second input resistor is coupled to the node, and the other end of the second input resistor is coupled to ground. The controller receives the reference voltage signal from the reference voltage regulator and receives a divided voltage signal from the node respectively, and outputs a setting voltage signal to the output stage.

### CROSS-REFERENCE TO RELATED APPLICATIONS

This non-provisional application claims priority under 35 U.S.C. §119(a) on Patent Application No(s). 101133510 filed in Taiwan, R.O.C. on Sep. 13, 2012, the entire contents of which are hereby incorporated by reference.

### BACKGROUND OF THE INVENTION

1. Field of the Invention

The invention relates to the driving of a light-emitting diode (LED); in particular, to a LED driving apparatus and operating method thereof.

2. Description of the Prior Art

In general, the operation theorem of the conventional AC to DC type of LED driving circuit is to use an AC to DC converter to generate the input voltage needed to conduct upper side of the LED to drive the LED to emit lights, and simultaneously disposes a current source circuit at lower side of the LED to control the fixed current flowing through the LED to the ground terminal, and the brightness of the LED can be stabilized. Since the input voltage is a rectified signal instead of DC voltage, the LED driving circuit is necessary to drive the LED to achieve better power factor (PF) and luminous efficiency.

However, the setting voltage outputted from the setting voltage generator to the current source circuit at lower side of the LED is changed with the input voltage in the prior art; therefore, as shown in the wave-form diagrams of its input voltage, LED current, and power consumption of FIG. 1A˜FIG. 1C, the LED current (I_{LED}) is changed with different input voltages. When the input voltage becomes larger, the LED current (I_{LED}) also becomes larger; therefore, it will cause the problem of inaccurate LED current at different input voltages (high input voltage VH and low input voltage VL), namely the problem of poor input voltage line regulation. In addition, because both the voltage and current of the current source circuit disposed at the lower side of the LED become larger, the power consumption will also become larger to cause the overheat problem.

Therefore, the invention provides a LED driving apparatus and operating method thereof to solve the above-mentioned problems occurred in the prior arts.

### SUMMARY OF THE INVENTION

An embodiment of the invention is a LED driving apparatus. In this embodiment, the LED driving apparatus includes an output stage, a reference voltage regulator, a first input resistor, a second input resistor, and a controller. The output stage includes at least one LED. The reference voltage regulator is coupled to an input voltage and used to receive the input voltage and output a reference voltage signal. One end of the first input resistor is coupled to a node. One end of the second input resistor is coupled to the node, and another end of the second input resistor is coupled to a ground terminal. The controller receives the reference voltage signal from the reference voltage regulator and receives a divided voltage signal from the node respectively, and outputs a setting voltage signal to the output stage.

In an embodiment, another end of the first input resistor is coupled to the input voltage, and the first input resistor and the second input resistor divide the input voltage into the divided voltage signal.

In an embodiment, another end of the first input resistor is coupled to a LED voltage, and one end of the LED is coupled to the LED voltage, and the first input resistor and the second input resistor divide the LED voltage into the divided voltage signal.

In an embodiment, one end of the LED is coupled to a LED voltage, the output stage further includes a setting resistor unit, a transistor unit, and an amplifier, one end of the setting resistor unit is coupled to the ground terminal, the transistor unit is coupled between another end of the LED and the setting resistor unit, two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

Another embodiment of the invention is a LED driving apparatus operating method. In this embodiment, the LED driving apparatus includes an output stage, a reference voltage regulator, a first input resistor, a second input resistor, and a controller. The output stage includes at least one LED. The reference voltage regulator is coupled to an input voltage, one end of the first input resistor is coupled to a node, one end of the second input resistor is coupled to the node and another end of the second input resistor is coupled to a ground terminal.

The LED driving apparatus operating method includes steps of: (a) the reference voltage regulator receiving the input voltage and outputting a reference voltage signal; and (b) the controller receiving the reference voltage signal and a divided voltage signal from the reference voltage regulator and the node respectively and outputting a setting voltage signal to the output stage.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) making the LED to work at the best current corresponding brightness point.

The advantage and spirit of the invention may be understood by the following detailed descriptions together with the appended drawings.

### BRIEF DESCRIPTION OF THE APPENDED DRAWINGS

FIG. 1A˜FIG. 1C illustrate wave-form diagrams of input voltage, LED current, and power consumption of the LED driving apparatus in prior art respectively.

FIG. 2 illustrates a schematic diagram of the circuit structure of the LED driving apparatus in an embodiment of the invention.

FIG. 3A˜FIG. 3C illustrate wave-form diagrams of input voltage, LED current, and power consumption of the LED driving apparatus in FIG. 2 respectively.

FIG. 4 illustrates a schematic diagram of the circuit structure of the LED driving apparatus in another embodiment of the invention.

FIG. 5A˜FIG. 5C illustrate wave-form diagrams of input voltage, LED current, and power consumption of the LED driving apparatus in FIG. 4 respectively.

FIG. 6 illustrates a schematic diagram of the circuit structure of the LED driving apparatus in another embodiment of the invention.

FIG. 7 illustrates a flow chart of the LED driving apparatus operating method in another embodiment of the invention.

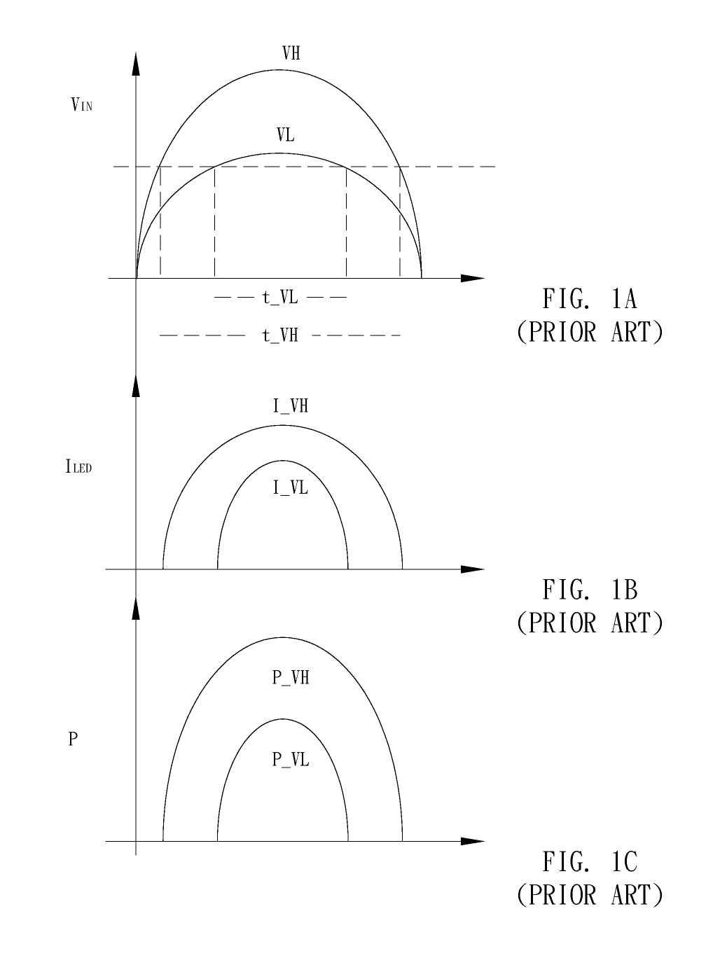

### DETAILED DESCRIPTION OF THE INVENTION

An embodiment of the invention is a LED driving apparatus. In this embodiment, the LED driving apparatus is used to drive the LED to emit lights, but not limited to this.

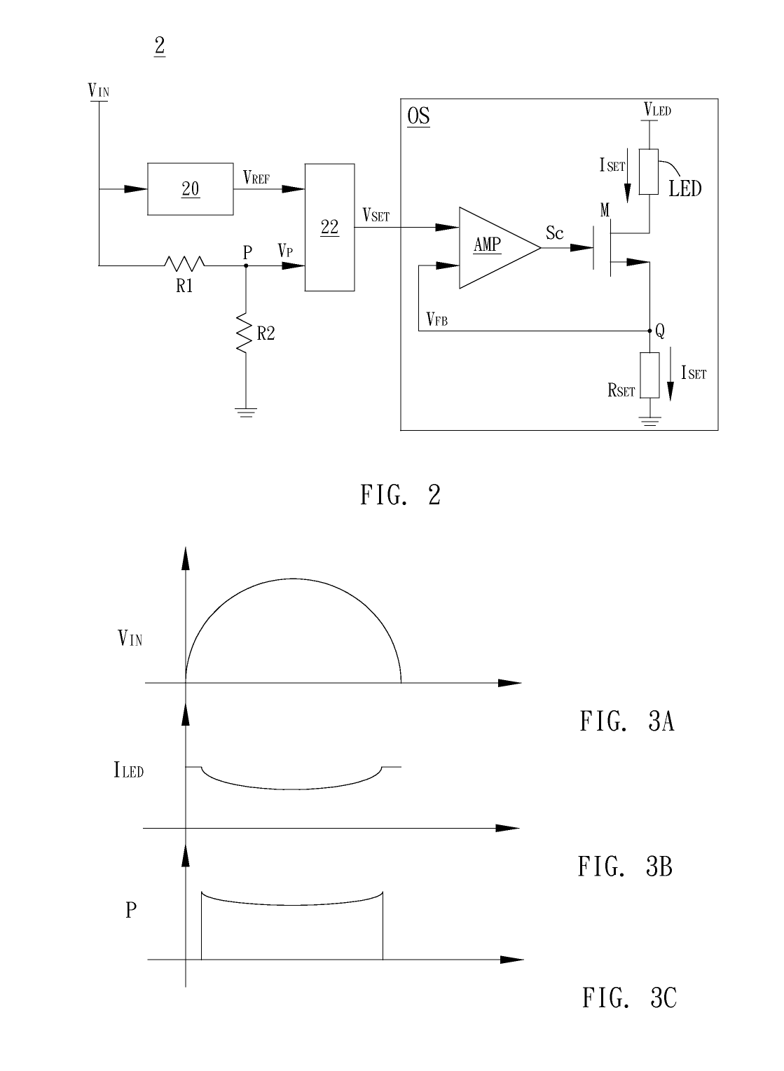

Please refer to FIG. 2. FIG. 2 illustrates a schematic diagram of the circuit structure of the LED driving apparatus in this embodiment. As shown in FIG. 2, the LED driving apparatus 2 includes an output stage OS, a reference voltage regulator 20, a first input resistor R1, a second input resistor R2, and a controller 22. In fact, the controller 22 can be a subtractor or a proportional integrator, but not limited to this.

The reference voltage regulator 20 is coupled to an input voltage V_{IN} and the controller 22. One end of the first input resistor R1 is coupled to the input voltage V_{IN} and another end of the first input resistor R1 is coupled to a node P. One end of the second input resistor R2 is coupled to the node P, and another end of the second input resistor R2 is coupled to a ground terminal. The controller 22 is coupled to the reference voltage regulator 20, the node P, and the output stage OS.

The output stage OS includes at least one light-emitting diode LED, a setting resistor unit R_{SET}, a transistor unit M, and an amplifier AMP. One end of the setting resistor unit R_{SET} is coupled to the ground terminal, and another end of the setting resistor unit R_{SET} is coupled to the transistor unit M. The transistor unit M is coupled between the light-emitting diode LED and the setting resistor unit R_{SET}. The light-emitting diode LED is coupled between a LED voltage V_{LED} and the transistor unit M. Two input terminals of the amplifier AMP are coupled to the controller 22 and a node Q between the transistor unit M and the setting resistor unit R_{SET} respectively. An output terminal of the amplifier AMP is coupled to a gate electrode of the transistor unit M.

The reference voltage regulator 20 receives the input voltage V_{IN} and generates a reference voltage signal V_{REF} to the controller 22. After the input voltage V_{IN} is divided by the first input resistor R1 and the second input resistor R2, the controller 22 will receive a divided voltage signal V_{P} from the node P. After the controller 22 receives the reference voltage signal V_{REF} and the divided voltage signal V_{P} respectively, the controller 22 will generate a setting voltage signal V_{SET} according to the reference voltage signal V_{REF} and the divided voltage signal V_{P} and outputs the setting voltage signal V_{SET} to the amplifier AMP of the output stage OS.

In the output stage OS, a LED current I_{LED} flowing through at least one light-emitting diode LED can be generated by a current source, and the stable LED current I_{LED} can be used to control the brightness of the at least one light-emitting diode LED. As to a setting current I_{SET} flowing through the setting resistor unit R_{SET}, when the transistor unit M is operated in a saturation region, a current value of the setting current I_{SET} is equal to a voltage value of the reference voltage signal V_{REF} divided by a resistance of the setting resistor unit R_{SET}.

In fact, a high-voltage MOSFET can be disposed as a switch to a drain electrode of the transistor unit M, but not limited to this. In addition, the amplifier AMP, the transistor unit M, and the setting resistor unit R_{SET} can form a negative feedback circuit.

The two input terminals of the amplifier AMP in the output stage OS receive the setting voltage signal V_{SET} from the controller 22 and a sensed voltage signal V_{FB} from the node Q between the transistor unit M and the setting resistor unit R_{SET} respectively. The amplifier AMP will compare the setting voltage signal V_{SET} with the sensed voltage signal V_{FB} to generate a comparison result and generate a switch control signal Sc according to the comparison result, and the output terminal will output the switch control signal Sc to the transistor unit M to control the transistor unit M on or off.

Please refer to FIG. 3A through FIG. 3C. FIG. 3A˜FIG. 3C illustrate wave-form diagrams of the input voltage V_{IN}, the LED current I_{LED}, and the power consumption P of the LED driving apparatus 2 in FIG. 2 respectively. As shown in FIG. 3B, when the input voltage V_{IN} becomes larger, the current value of the LED current I_{LED} will become smaller. Thus, as shown in FIG. 3C, since the power consumption P of the LED driving apparatus 2 equals to the product of the current value of the LED current I_{LED} and the voltage value of the LED voltage V_{LED}, when the input voltage V_{IN} becomes larger, since the current value of the LED current I_{LED} becomes smaller, the power consumption P of the LED driving apparatus 2 will be decreased instead of being increased. Therefore, the excessive power consumption problem and overheat problem can be effectively avoided.

Another embodiment of the invention is also a LED driving apparatus. In this embodiment, the LED driving apparatus is used to drive the LED to emit lights, but not limited to this.

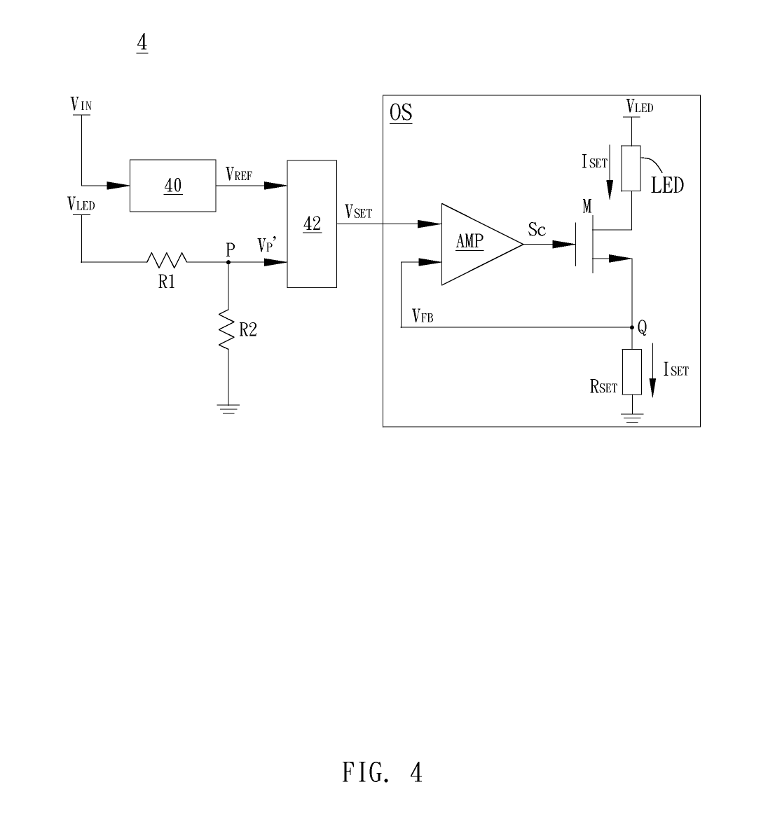

Please refer to FIG. 4. FIG. 4 illustrates a schematic diagram of the circuit structure of the LED driving apparatus in this embodiment. As shown in FIG. 4, the LED driving apparatus 4 includes an output stage OS, a reference voltage regulator 40, a first input resistor R1, a second input resistor R2, and a controller 42. In fact, the controller 42 can be a subtractor or a proportional integrator, but not limited to this.

The reference voltage regulator 40 is coupled to an input voltage V_{IN} and the controller 42. One end of the first input resistor R1 is coupled to the LED voltage V_{LED} instead of the input voltage V_{IN} and another end of the first input resistor R1 is coupled to a node P. One end of the second input resistor R2 is coupled to the node P, and another end of the second input resistor R2 is coupled to a ground terminal. The controller 42 is coupled to the reference voltage regulator 40, the node P, and the output stage OS.

The output stage OS includes at least one light-emitting diode LED, a setting resistor unit R_{SET}, a transistor unit M, and an amplifier AMP. One end of the setting resistor unit R_{SET} is coupled to the ground terminal, and another end of the setting resistor unit R_{SET} is coupled to the transistor unit M. The transistor unit M is coupled between the light-emitting diode LED and the setting resistor unit R_{SET}. The light-emitting diode LED is coupled between a LED voltage V_{LED} and the transistor unit M. Two input terminals of the amplifier AMP are coupled to the controller 42 and a node Q between the transistor unit M and the setting resistor unit R_{SET} respectively. An output terminal of the amplifier AMP is coupled to a gate electrode of the transistor unit M.

The reference voltage regulator 40 receives the input voltage V_{IN} and generates a reference voltage signal V_{REF} to the controller 42. After the LED voltage V_{LED} is divided by the first input resistor R1 and the second input resistor R2, the controller 42 will receive a divided voltage signal V_{P}′ from the node P. After the controller 42 receives the reference voltage signal V_{REF} and the divided voltage signal V_{P}′ respectively, the controller 42 will generate a setting voltage signal V_{SET} according to the reference voltage signal V_{REF} and the divided voltage signal V_{P}′ and outputs the setting voltage signal V_{SET} to the amplifier AMP of the output stage OS.

In the output stage OS, a LED current I_{LED} flowing through at least one light-emitting diode LED can be generated by a current source, and the stable LED current I_{LED} can be used to control the brightness of the at least one light-emitting diode LED. As to a setting current I_{SET} flowing through the setting resistor unit R_{SET}, when the transistor unit M is operated in a saturation region, a current value of the setting current I_{SET} is equal to a voltage value of the reference voltage signal V_{REF} divided by a resistance of the setting resistor unit R_{SET}.

In fact, a high-voltage MOSFET can be disposed as a switch to a drain electrode of the transistor unit M, but not limited to this. In addition, the amplifier AMP, the transistor unit M, and the setting resistor unit R_{SET} can form a negative feedback circuit.

The two input terminals of the amplifier AMP in the output stage OS receive the setting voltage signal V_{SET} from the controller 42 and a sensed voltage signal V_{FB} from the node Q between the transistor unit M and the setting resistor unit R_{SET} respectively. The amplifier AMP will compare the setting voltage signal V_{SET} with the sensed voltage signal V_{FB} to generate a comparison result and generate a switch control signal Sc according to the comparison result, and the output terminal will output the switch control signal Sc to the transistor unit M to control the transistor unit M on or off.

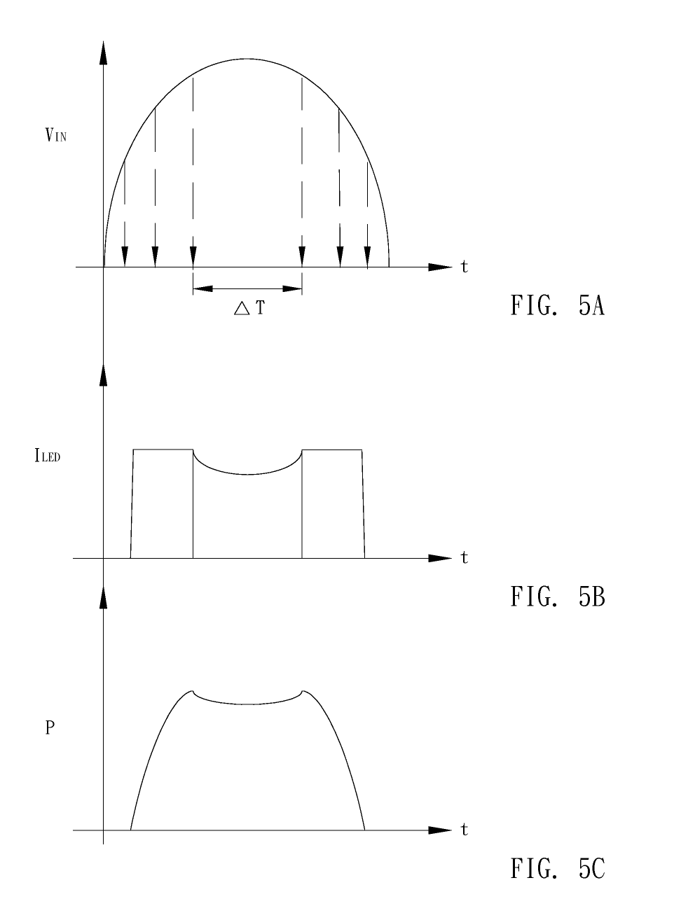

Please refer to FIG. 5A through FIG. 5C. FIG. 5A˜FIG. 5C illustrate wave-form diagrams of the input voltage V_{IN}, the LED current I_{LED}, and the power consumption P of the LED driving apparatus 4 in FIG. 4 respectively. As shown in FIG. 5B, during a period ΔT of the light-emitting diode being turned on, when the input voltage V_{IN} becomes larger, the current value of the LED current I_{LED} will become smaller. Thus, as shown in FIG. 5C, when the input voltage V_{IN} becomes larger, since the current value of the LED current I_{LED} becomes smaller, the power consumption P of the light-emitting diode LED will be decreased instead of being increased. Therefore, the excessive power consumption problem and overheat problem can be effectively avoided.

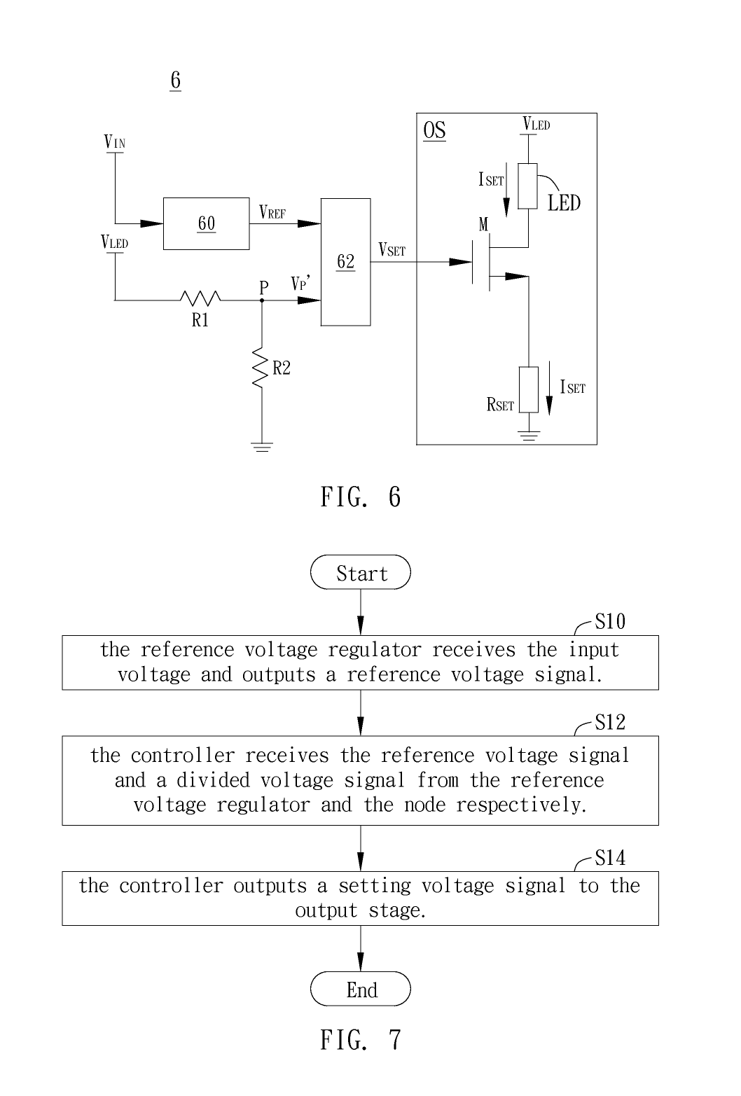

Please refer to FIG. 6. FIG. 6 illustrates a schematic diagram of the circuit structure of the LED driving apparatus in this embodiment. As shown in FIG. 6, the LED driving apparatus 6 includes an output stage OS, a reference voltage regulator 60, a first input resistor R1, a second input resistor R2, and a controller 62. Different from FIG. 4, the output stage OS in FIG. 6 includes at least one light-emitting diode LED, a setting resistor unit R_{SET}, and a transistor unit M, but not include an amplifier AMP. And, the output stage OS in FIG. 6 includes no negative feedback circuit of FIG. 4. Therefore, the controller 62 is directly coupled to a gate electrode of the transistor unit M and output the setting voltage signal V_{SET} to the gate electrode of the transistor unit M to control the transistor unit M on or off.

Another embodiment of the invention is a LED driving apparatus operating method. In this embodiment, the LED driving apparatus includes an output stage, a reference voltage regulator, a first input resistor, a second input resistor, and a controller. The output stage includes at least one LED. The reference voltage regulator is coupled to an input voltage, one end of the first input resistor is coupled to a node, one end of the second input resistor is coupled to the node and another end of the second input resistor is coupled to a ground terminal.

Please refer to FIG. 7. FIG. 7 illustrates a flow chart of the LED driving apparatus operating method in this embodiment. As shown in FIG. 7, that at first, the method performs step S10, the reference voltage regulator receives the input voltage and outputs a reference voltage signal. Then, the method performs step S12, the controller receives the reference voltage signal and a divided voltage signal from the reference voltage regulator and the node respectively. Afterward, the method performs step S14, the controller outputs a setting voltage signal to the output stage.

In an embodiment, another end of the first input resistor is coupled to the input voltage, and the first input resistor and the second input resistor divide the input voltage into the divided voltage signal. One end of the LED is coupled to a LED voltage, the output stage further includes a setting resistor unit, a transistor unit, and an amplifier, one end of the setting resistor unit is coupled to the ground terminal. The transistor unit is coupled between another end of the LED and the setting resistor unit.

Two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

In another embodiment, another end of the first input resistor is coupled to a LED voltage, and one end of the LED is coupled to the LED voltage, and the first input resistor and the second input resistor divide the LED voltage into the divided voltage signal.

The output stage can further include a setting resistor unit, a transistor unit, and an amplifier, one end of the setting resistor unit is coupled to the ground terminal, the transistor unit is coupled between another end of the LED and the setting resistor unit, two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

In addition, the output stage further can only include a setting resistor unit and a transistor unit without any amplifier. One end of the setting resistor unit is coupled to the ground terminal; the transistor unit is coupled between another end of the LED and the setting resistor unit. A gate electrode of the transistor unit is coupled to the controller to receive the setting voltage signal from the controller.

Compared to the prior art, the LED driving apparatus and operating method thereof can achieve the effects of: (1) effectively avoiding the excessive power consumption problem and overheat problem when the input voltage is excessive; (2) effectively avoiding the problem of inaccurate LED current at different input voltages, namely the problem of poor input voltage line regulation; (3) making the LED to work at the best current corresponding brightness point.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A LED driving apparatus, comprising:
an output stage, comprising at least one LED;
a reference voltage regulator, coupled to an input voltage, for receiving the input voltage and outputting a reference voltage signal;
a first input resistor, wherein one end of the first input resistor is coupled to a node;
a second input resistor, wherein one end of the second input resistor is coupled to the node and another end of the second input resistor is coupled to a ground terminal; and
a controller, coupled to the reference voltage regulator and the node respectively, for receiving the reference voltage signal and a divided voltage signal from the reference voltage regulator and the node respectively and outputting a setting voltage signal to the output stage.

2. The LED driving apparatus of claim 1, wherein another end of the first input resistor is coupled to the input voltage, and the first input resistor and the second input resistor divide the input voltage into the divided voltage signal.

3. The LED driving apparatus of claim 1, wherein another end of the first input resistor is coupled to a LED voltage, and one end of the LED is coupled to the LED voltage, and the first input resistor and the second input resistor divide the LED voltage into the divided voltage signal.

4. The LED driving apparatus of claim 2, wherein one end of the LED is coupled to a LED voltage, the output stage further comprises:
a setting resistor unit, wherein one end of the setting resistor unit is coupled to the ground terminal;
a transistor unit, coupled between another end of the LED and the setting resistor unit; and
an amplifier, wherein two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

5. The LED driving apparatus of claim 3, wherein the output stage further comprises:
a setting resistor unit, wherein one end of the setting resistor unit is coupled to the ground terminal;
a transistor unit, coupled between another end of the LED and the setting resistor unit; and
an amplifier, wherein two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

6. The LED driving apparatus of claim 3, wherein the output stage further comprises:
a setting resistor unit, wherein one end of the setting resistor unit is coupled to the ground terminal; and
a transistor unit, coupled between another end of the LED and the setting resistor unit, and a gate electrode of the transistor unit is coupled to the controller to receive the setting voltage signal from the controller.

7. The LED driving apparatus of claim 1, wherein the controller is a subtractor or a proportional integrator.

8. A method of operating a LED driving apparatus, the LED driving apparatus comprising an output stage, a reference voltage regulator, a first input resistor, a second input resistor, and a controller, and the output stage comprising at least one LED, the reference voltage regulator being coupled to an input voltage, one end of the first input resistor being coupled to a node, one end of the second input resistor being coupled to the node and another end of the second input resistor being coupled to a ground terminal, the method comprising steps of:
(a) the reference voltage regulator receiving the input voltage and outputting a reference voltage signal; and
(b) the controller receiving the reference voltage signal and a divided voltage signal from the reference voltage regulator and the node respectively and outputting a setting voltage signal to the output stage.

9. The method of claim 8, wherein another end of the first input resistor is coupled to the input voltage, and the first input resistor and the second input resistor divide the input voltage into the divided voltage signal.

10. The method of claim 8, wherein another end of the first input resistor is coupled to a LED voltage, and one end of the LED is coupled to the LED voltage, and the first input resistor and the second input resistor divide the LED voltage into the divided voltage signal.

11. The method of claim 9, wherein one end of the LED is coupled to a LED voltage, the output stage further comprises a setting resistor unit, a transistor unit, and an amplifier, one end of the setting resistor unit is coupled to the ground terminal, the transistor unit is coupled between another end of the LED and the setting resistor unit, two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

12. The method of claim 10, wherein the output stage further comprises a setting resistor unit, a transistor unit, and an amplifier, one end of the setting resistor unit is coupled to the ground terminal, the transistor unit is coupled between another end of the LED and the setting resistor unit, two input terminals of the amplifier are coupled to the controller and between the transistor unit and the setting resistor unit respectively, the two input terminals receive the setting voltage signal from the controller and a sensed voltage signal between the transistor unit and the setting resistor unit respectively, an output terminal of the amplifier is coupled to a gate electrode of the transistor unit and the output terminal outputs a switch control signal to the transistor unit.

13. The method of claim 10, wherein the output stage further comprises a setting resistor unit and a transistor unit, one end of the setting resistor unit is coupled to the ground terminal, the transistor unit is coupled between another end of the LED and the setting resistor unit, and a gate electrode of the transistor unit is coupled to the controller to receive the setting voltage signal from the controller.
